(19) United States
(12) Patent Application Publication
(10) Pub. No.: US 2004/0068523 A1
(43) Pub. Date: Apr. 8, 2004

(54) Method and system for full asynchronous master-to-master file synchronization

(76) Inventors: Robert Olan Keith JR., Modesto, CA (US); William Russell Henshall, San Francisco, CA (US)

Correspondence Address: Finnegan, Henderson, Farabow,, Garrett & Dunner, L.L.P., 1300 I Street, N.W., Washington, DC, 20005-3315, US

(21) Appl. No.: 10/267,052

(22) Filed: Oct. 7, 2002

(51) Int. Cl. G06F 12/00

(52) U.S. Cl. 707/200

(57) ABSTRACT

A method and system are disclosed for file synchronization between at least a first system and a second system coupled via a network. Each system has a file directory with one or more files. Information associated with a first file directory of the first system and information associated with a second file directory of the second system are obtained. The obtained information determines a layout of the first file directory and second file directory. The obtained information associated with the first and second file directories are stored. The stored information associated with the first file directory is compared with the information associated with the second file directory to determine if the first and second file directories match. At least one of the first file directory and the second file directory is modified if the file directories do not match to maintain synchronization of the file directories.

### FIELD

This invention relates generally to data sharing systems, and, more particularly, to a method and system for full asynchronous master-to-master file synchronization.

### BACKGROUND

Today, a large number of disparate users in remote or local areas can share vast amounts of information via one or more networks. These networks can include a local area network (LAN) or a wide area network (WAN) such as the Internet interconnecting any number of computing devices. The computing devices can access and share information with each other. Typically, the information is stored in data files (“files”). The computing devices can manage the files in one or more file directories. Because files can be shared, many applications require file synchronization between computing systems that is multiple copies of the same file must contain the same data. For example, in a collaborative environment, users can share and make changes to information in copies of the same file stored locally or in a remote location. If the same file is stored on more than one computing system, changes to the file must be synchronized across each computing system to maintain file consistency and uniformity.

One prior file synchronization technique is “master-to-slave” file synchronization. This technique replicates the file system of one system (“slave system”) with the file system of another file system (“master system”) in one direction. For instance, only changes that are made on the master system are replicated on the slave system, and not vice versa. One disadvantage of this type of synchronization is that file changes on the slave system are not replicated at the master system. In such a case, users that access the master system will not know of changes on the slave system. Another disadvantage of this prior technique is that a user typically initiates the file synchronization of the master system on the slave system. Thus, the slave system does not receive changes until the user initiates the synchronization. This can be problematic if multiple changes occur to the same file on the master system and the user does not initiate file synchronization for each change. In such a case, a user accessing the file on the slave system will not know of each change made to the file on the master system. In many applications, maintaining consistency and uniformity for each file change is critical.

There exists, therefore, a need for an improved file synchronization method and system that overcomes the disadvantages of prior file synchronization techniques.

### SUMMARY

According to one aspect of the invention, a method is disclosed for file synchronization between at least a first system and a second system coupled via a network. Each system has a file directory with one or more files. Information associated with a first file directory of the first system and information associated with a second file directory of the second system are obtained. The obtained information determines a layout of the first file directory and second file directory. The obtained information associated with the first and second file directories are stored. The stored information associated with the first file directory is compared with the information associated with the second file directory to determine if the first and second file directories match. At least one of the first file directory and the second file directory is modified if the file directories do not match to maintain synchronization of the file directories.

According to another aspect of the invention, a computing system is disclosed comprising a mounting module and a synchronization module. The mounting module is to mount a first image of a file directory of a local system and a second image of the file directory of the local system. The synchronization module is to compare the first image and the second image of the file directory of the local system in determining a change in the file directory of the local system and to synchronize the file directory of the local system with a file directory of a remote system if a change is determined.

Other features and advantages will be apparent from the accompanying drawings, and from the detailed description, which follows below.

### BRIEF DESCRIPTION OF THE DRAWINGS

The accompanying drawings, which are incorporated in, and constitute a part of, this specification illustrate exemplary implementations of the invention and, together with the detailed description, serve to explain the principles of the invention. In the drawings,

FIG. 1 illustrates one example network environment for practicing the invention;

FIG. 2 illustrates another example network environment for practicing the invention;

FIG. 3 illustrates an exemplary block diagram of internal components of a computing system for implementing the invention;

FIG. 4 illustrates exemplary internal hardware/software component layers within the computing system of FIG. 3;

FIG. 5 illustrates a basic flow diagram of a method for file synchronization on multiple systems;

FIG. 6 illustrates a flow diagram of a method for file synchronization on multiple systems based on a file modification;

FIG. 7 illustrates a flow diagram of a method for file synchronization on multiple systems based on a file addition;

FIG. 8 illustrates a flow diagram of a method for file synchronization on multiple systems based on a file deletion;

FIG. 9 illustrates an exemplary file directory image;

FIG. 10 illustrates exemplary file attributes;

FIG. 11 illustrates a diagram for comparing file directory images; and

FIG. 12 illustrates an exemplary peer-to-peer server networking environment for secured file synchronization.

### DETAILED DESCRIPTION

Reference will now be made in detail to implementations of the invention, examples of which are illustrated in the accompanying drawings. Wherever possible, the same reference numbers will be used throughout the drawings to refer to the same or like parts.

A. Overview

File synchronization techniques are disclosed that overcome the limitations associated with prior synchronization techniques and provide full asynchronous master-to-master file synchronization. The following techniques allow file synchronization among multiple systems, and each system can be a master system to initiate file synchronization. For example, in a two-master system, if a file change is made on one master system, the change is propagated to the other master system, and vice versa. In this manner, file consistency and uniformity can be maintained across multiple systems in multiple directions.

In one implementation, to propagate the file synchronization, one or more network appliances can be used. A network appliance can traverse a local system to obtain an image of its file directory. That is, the network appliance can determine how the file directory is composed on the local system. If a change is made to the file directory, the network appliance can detect it by using the image of the file directory and propagate the change to a remote system in order for the remote system to update its file directory accordingly to maintain file synchronization with the file directory of the local system.

The following synchronization techniques provide file synchronization between at least a first system and a second system coupled via a network. Each system has a file directory with one or more files. Information associated with a first file directory of the first system and information associated with a second file directory of the second system are obtained. The obtained information associated with the first and second file directories are stored. The stored information associated with the first file directory is compared with the information associated with the second file directory to determine if the first and second file directories match. At least one of the first file directory and the second file directory is modified if the file directories do not match to maintain synchronization of the file directories.

B. Systems Overview

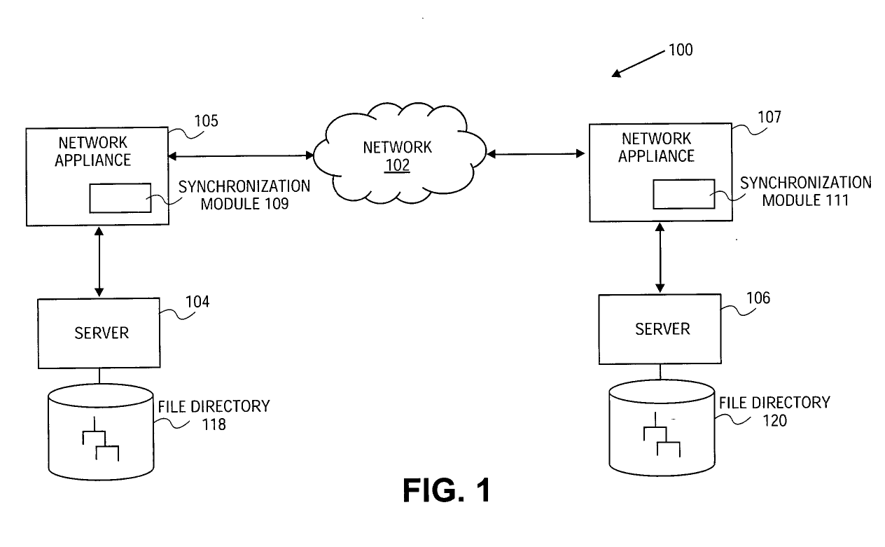

FIG. 1 illustrates one example network environment 100 for practicing the invention. The network environment 100 includes a first network appliance 105 coupled to a second network appliance 107 via a network 102. Appliances 105 and 107 may be, for example, network devices, and include synchronization modules 109 and 111, respectively, to be described below in greater detail.

Coupled to first and second network appliances 105 and 107 are servers 104 and 106, respectively. Servers 104 and 106 include file directories 118 and 120, respectively. Each file directory can have one or more files and subdirectories with one or more files. File directories 118 and 120 can be maintained in a database or in one or more storage devices for a respective server. In this example, network 102 can be a wide area network (WAN) such as the Internet. Network environment 100 can be configured for a web-based, shared-file networking environment. For example, the servers and appliances can implement shared file system protocols such as SMB for Microsoft NT® file systems, AFP for the Apple® Filer Protocol, or NFS for Unix based systems.

Servers 104 and 106 are computing device such as, for example, personal computers or workstations. Servers 104 and 106 can include client/server software and/or hardware for implementing applications across network 102 such as web-based applications and shared file system protocols. File directories 118 and 120 can be stored in one or more storage devices, examples of which include a hard disk, compact disc read/write (CD R/W) drives, tape drives, random access memory (RAM), flash memory, or other like memory devices. The servers 104 and 106 can provide shared access to the files or subdirectories in file directories 118 and 120.

Network appliances (“appliances”) 105 and 107 are basic computing devices that can have networking capabilities and perform a specialized purpose. For example, appliance 105 can be designated for a local server 104 to maintain file synchronization between a local file directory 118 and a remote file directory 120 for a remote server 106. Likewise, appliance 107 can be designated for a local server 106 to maintain file synchronization between a local file directory 120 and a remote file directory 118 for remote server 104. Furthermore, the appliances 105 and 107 can perform other types of functions such as archiving data for the servers 104 and 106.

In order to perform file synchronization, the appliances 105 and 107 can “mount” the file system or directory of one or more computing devices. Mounting refers to the process of scanning the file system or directory of a computing device to obtain information regarding the makeup or layout of the file system. The obtained information may provide a map of each directory and subdirectory within the file system including a listing of the files and their attributes for each directory and subdirectory. The obtained information may also include records for each directory, subdirectory, and file. In this manner, obtained information regarding the file system or directory can thus provide an “image” on how the file system or directory is composed, which can be stored by the appliances 105 and 107 to perform file synchronization.

For example, appliance 105 can mount an image of the local file directory 118 and/or an image of the remote file directory 120 to obtain an image of the file systems for servers 104 and/or 106. Appliance 107 can also do the same. Mounting of images can include storing of information associated with file directories 118 and 120 on one or more memory devices. In a preferred implementation, the files that are synchronized are only stored in file directories 118 and 120. Alternatively, the appliances 105 and 107 can archive and store the files for servers 104 and 106 including the files in file directories 118 and 120.

Synchronization modules 109 and 111, which may be software modules, maintain file synchronization between file directories 118 and 120 across servers 104 and 106. Specifically, if a file change occurs in file directory 118, the synchronization module 109 for appliance 105 can detect the file change, update the information regarding the layout or makeup (“image”) of file directory 118, and propagate the file change (e.g., send a message) to synchronization module 111 on appliance 107 in order for the same file change to occur in file directory 120 of server 106. Similarly, synchronization module 111 on appliance 107 can perform the same function for a file change in file directory 120 of server 106 to maintain file synchronization with the file directory 118 of server 104. In this manner, file directory 118 can be synchronized with file directory 120. That is, each of these directories can have identical files and/or subdirectories.

Furthermore, appliances 105 and 107, by using synchronization modules 109 and 111, can extend consistent and uniform file sharing across multiple remote computing systems via any number of networks. More particularly, these modules can synchronize file directories for computing systems across network 102, which can be WAN. This allows for large amounts of data or files to be consistent with a master copy of the data or files. Synchronization modules 109 and 111 are described in further detail below.

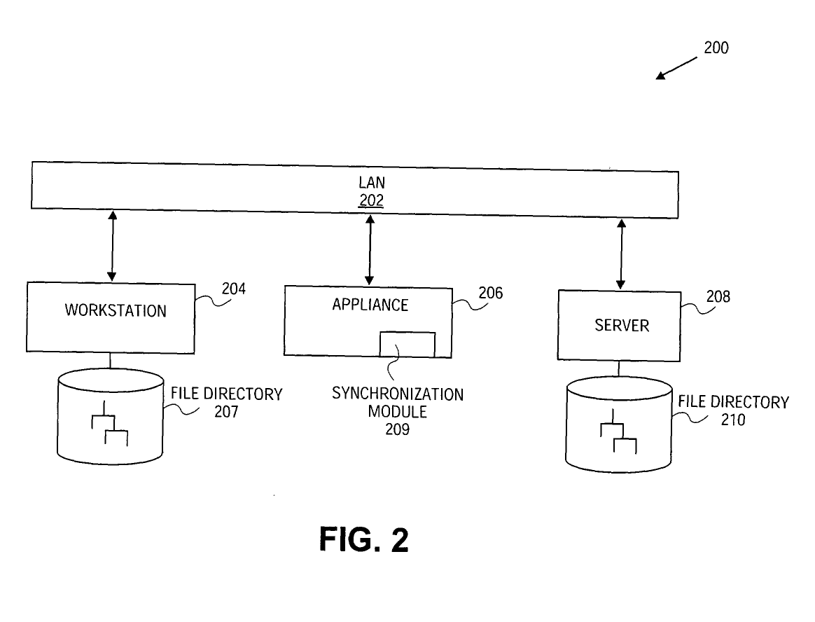

FIG. 2 illustrates another example network environment 200 for practicing the invention. The example of FIG. 2 illustrates a LAN environment for file synchronization. Networking environment 200 includes a workstation 204, appliance 206, and a server 208 all interconnected via a LAN 202. Workstation 204 and server 208 may be general purpose computers, and appliance 206 may be a networking device.

Coupled to workstation 204 and server 208 are file directory 207 and 210, respectively. File directories 207 and 210 can be shared directories like file directories 118 and 120 described in FIG. 1. Appliance 206 services workstation 204 and server 208 and maintains file synchronization for those computing devices. Appliance 206 includes a synchronization module 209 and can store information of file directories, .e.g., images of file directories 207 and 210. Synchronization module 206, which may be a software module, can maintain file synchronization if a file change occurs in file directory 210 or file directory 207 using the file synchronization techniques described below.

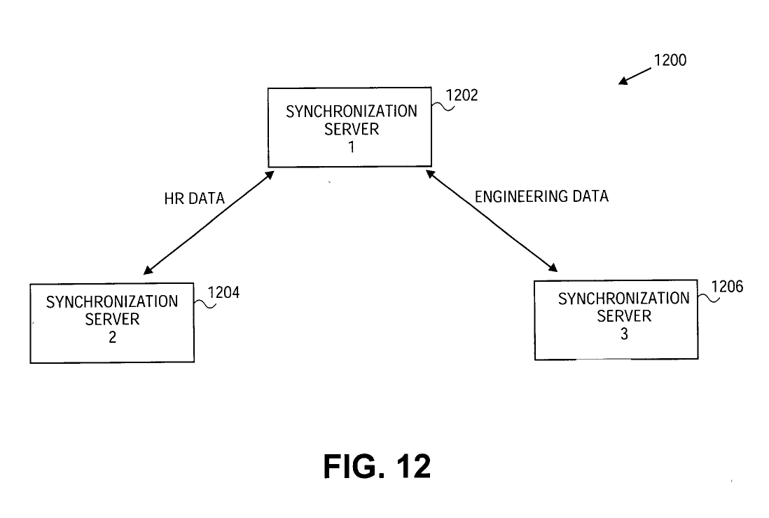

The above example network environments illustrated in FIGS. 1 and 2 can have many variations. In particular, any of the computing devices can be loaded with a synchronization module described herein to synchronize file directories across multiple systems. Furthermore, the appliances can be connected in many configurations including daisy-chain, star-based, central server, or fully meshed network configuration. Furthermore, the computing systems can be configured to provide incoming and outgoing security using firewalls and/or data encryption/decryption techniques as described in FIG. 12.

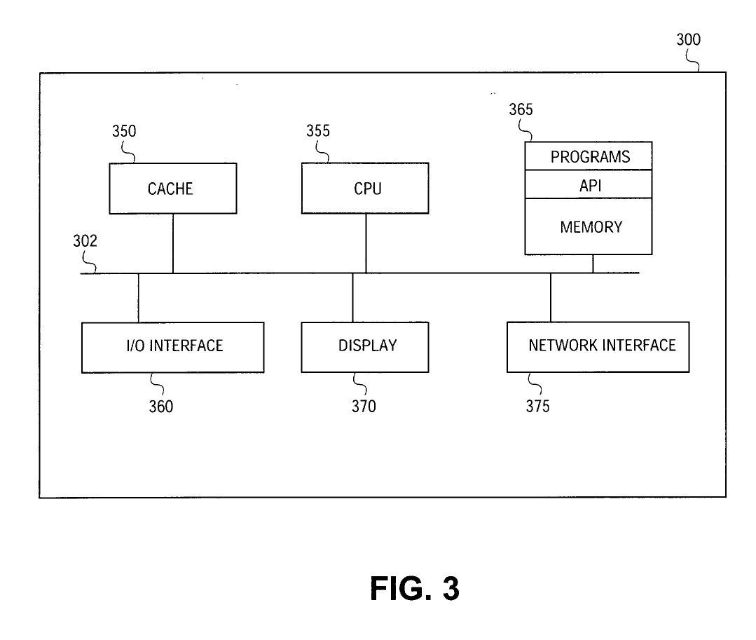

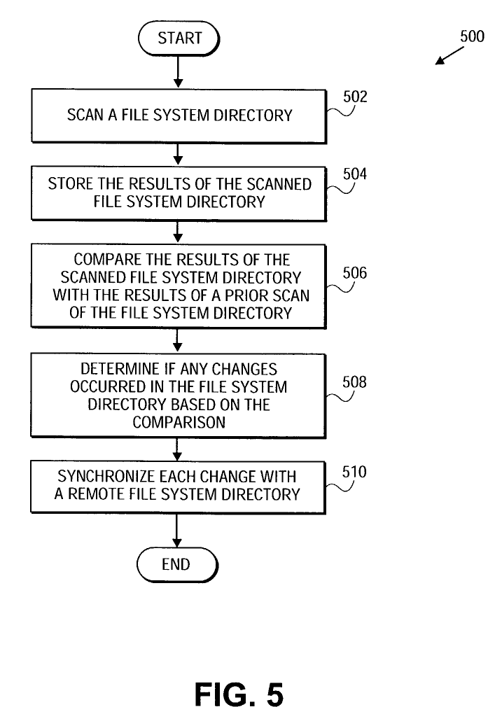

FIG. 3 illustrates an exemplary block diagram of internal components of a computing device 300, which may be for implementing the invention. Computing device 300 may represent the internal components of appliances 105 and 107 and servers 104 and 106 shown in FIG. 1 and workstation 204, appliance 206, and server 208 shown in FIG. 2. These components can be used to perform the file synchronization techniques described in FIGS. 5-8.

Computing system 300 includes several components all interconnected via a system bus 302. System bus 260 can be bidirectional system bus having thirty-two data and address lines for accessing a memory 365 and a cache memory 350 for transferring and storing data to and from components of device 300 or from other computing devices. Alternatively, multiplexed data/address lines may be used instead of separate data and address lines. Examples of memory 365 and cache memory 350 include a random access memory (RAM), read-only memory (ROM), video memory, flash memory, or other appropriate memory devices. Additional memory devices (not shown) may be included in computing system 300 such as, for example, fixed and removable media (including magnetic, optical, or magnetic optical storage media). These types of media may also operate as a cache memory.

Computing device 300 may communicate with other computing devices (e.g., central server servers 104 and 105 if representing appliances 105 or 107) via a network interface 375. Examples of network interface 375 may include Ethernet, telephone, or broadband connections. Computing device 300 includes a central processing unit (CPU) 355, examples of which include the Pentium® family of microprocessors manufactured by Intel® Corporation. However, any other suitable microprocessor, micro-, mini-, or mainframe type processor may be used as the CPU for the computing system 300. CPU 255 provides the support for storing, transferring, and modifying files to carry out the file synchronization techniques described herein.

Memory 365 may store instructions or code for implementing programs (e.g., synchronization modules 109, 111, or 209) and an application programming interface (API) to one or more other programs or operating systems. For example, CPU 355 may execute instructions for the synchronization modules to perform the file synchronization techniques described herein. Cache memory 350 may store files for sending and receiving to and from other computing systems. Computing device 300 may also receive input data or instructions from any number of input/output (I/O) devices via an I/O interface 360. Examples of I/O devices may include a keyboard, pointing device, or other appropriate input devices. The I/O devices may also include external storage devices or computing systems or subsystems. Computing device 300 may also present information via, e.g., a browser, on a display 370.

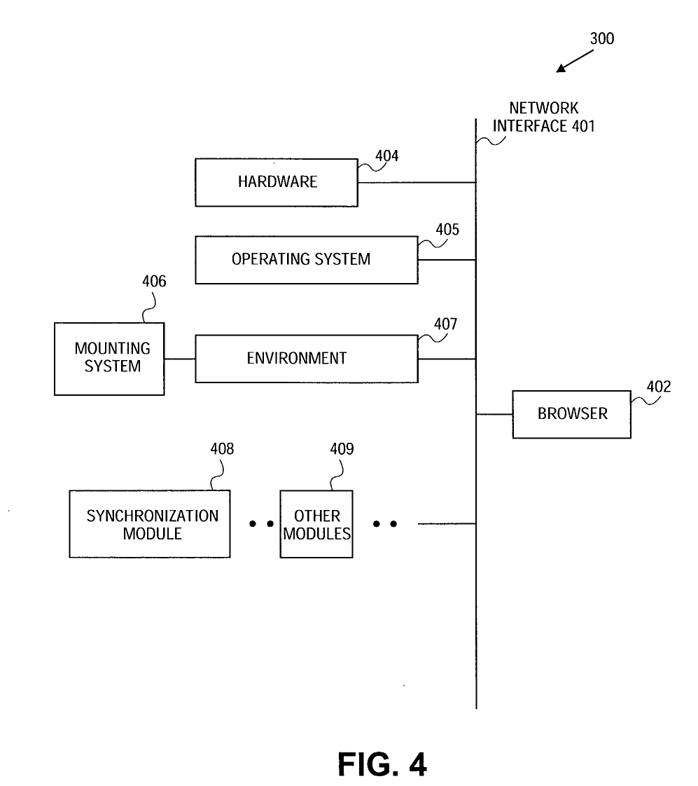

FIG. 4 illustrates exemplary internal hardware/software component layers within computing device 300 of FIG. 3. These component layers provide software components and network services to perform the file synchronization techniques described herein. Referring to FIG. 4, the example layers and components are implemented for the network appliances of FIGS. 1 and 2, however, the layers and components can be implemented for any of the computing devices. The layers and components include a hardware layer 404, operating system layer 405, a mounting system or module 406 associated with an environment layer 407, a browser 402, a synchronization module 408, and other modules 409.

Hardware layer 404 can include the CPU and memory devices. Operating system 405 can include a shared-networking operating system. Examples of operating system 405 may include Microsoft NT®, Unix, Apple share®, Linux OS, or other known operating systems. These operating systems can be customized for the network appliances and/or other computing devices to implement file synchronization. Environment layer 407 is customized for providing a shell to operate the synchronization module 408 or other modules 409 operating in the computing device 300. Environment layer 407 can operate with the mounting system or module 406, which can mount file systems or directories to obtain an image or layout of the file systems or directories. Browser 402 can provide an interface for operating the modules 408 and 409 and accessing and operating applications on the network 102 or 202. Each of these layers and components can communicate with other computing devices on other networks via the network interface 401.

Environment layer 407 can provide a command line interface to the appliance or computing system, and provide a dynamic web application environment. Such an environment can provide more user-friendly configuration, monitoring, and maintenance functionality. Browser 402 can allow a user to, e.g., operate a web application for maintaining mounted file systems, stop/start replication queues, monitor progress of file transfers, change or update synchronization parameters, etc. The following are exemplary synchronization parameters that can be used by the synchronization module 408 to implement the file synchronization techniques described herein:

Exemplary Synchronization Parameters

| | |
|---|---|
| Compress: | Whether to compress files before transfer |
| BWLimit: | A data transfer quota to limit the amount of Bandwidth |
| | used on the network. |
| Master/Slave: | Select wither to do Master—Master or |
| | Master-Slave replication |
| Port: | The network port to use for server to server connections |
| Exclude: | Individual files or wildcard masks of files to exclude |
| | from replications |
| Include: | Individual files or wildcard masks of files to include in |
| | replications |
| Partial: | Begin transferring where the transfer left off on partial |
| | files after interruptions |
| Delete: | Allow file deletions during replications |
| Existing: | Only replicate for existing files, do not create new files |
| Incremental: | Do incremental file transfers: only copy the changed |
| | portion of files |
| Archive: | Retain a copy of all changed or deleted files in the |
| | Archive folder |
| UseCRC: | Ignore time/date and do CRC calculations for file |
| | modifications |
| Dry-Run: | Run a simulation of the synchronization process |
| Cycle-Time: | Polling interval between checks for updates |
| | between file systems |

Mounting system or module 406 can implement many protocols being used on the network to mount remote systems. In one example, mounting system 406 can be implemented as an application interface (API) or a software module operating with operating system 405 to mount file directories of remote systems within, e.g., network appliances 105 and 107. Mounting system or module 406 can be implemented within synchronization module 408 in which a single module performs the mounting and synchronization functions.

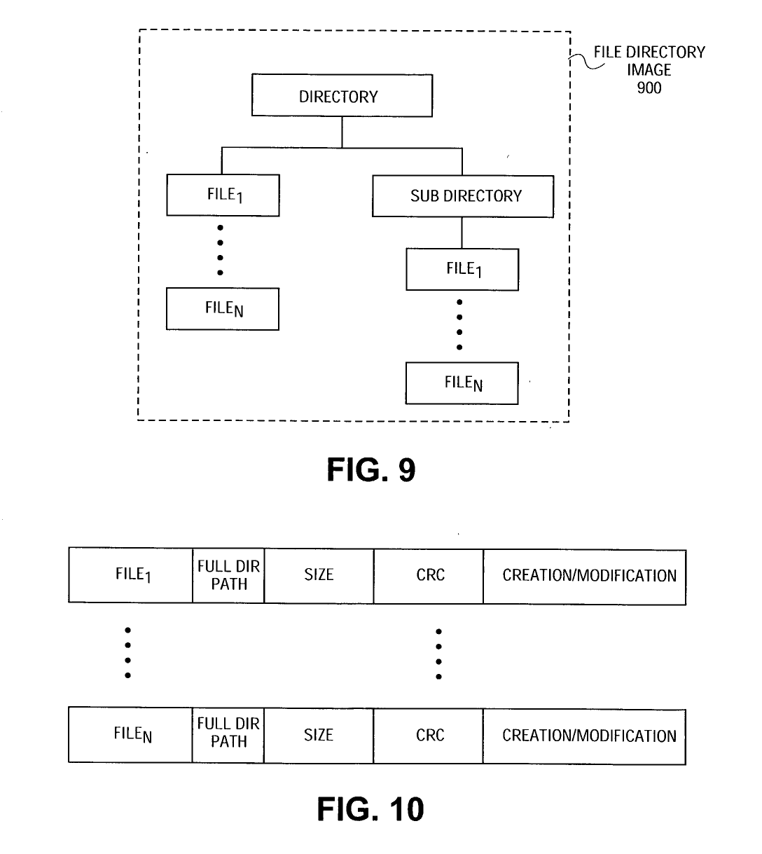

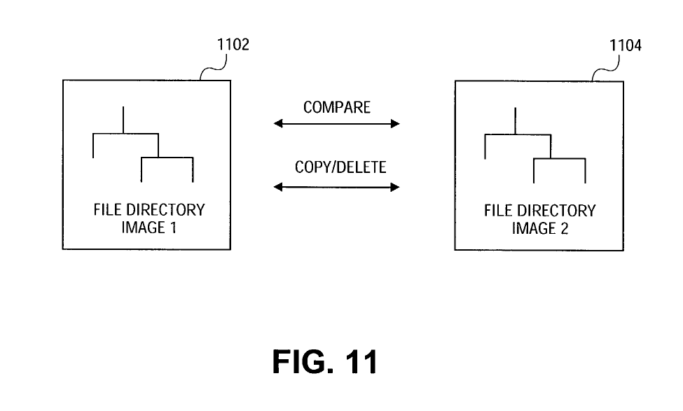

A single folder or even a file can be mounted for synchronization. As shown in FIG. 9, using standard shared-networking operating system protocol, a file directory image for each remote computing system, e.g., servers 104, 106, 208, or workstation 204 can be obtained and stored within the mounting system 406 of each computing system. More specifically, mounting system 406 can provide information on the directory layout and the files within the directory for each remote computing system. In one example, mounting system 406 can store the file directory image 900 and associated information such as that shown in FIG. 10. This information can include the “FILE NAME,” “FULL DIR PATH,” SIZE,” “CRC,” and “CREATION/MODIFICATION” information. Mounting system 406 can store multiple file directory images such as that shown in FIG. 11. In this example, a file directory image 1 (1102) and file directory image 2 (1104) are shown. Mounting module 405 can mount file directories and/or file systems that are identical to the file directories and/or file systems on each remote system.

Synchronization module 408, which can be the same as modules 109, 111, and 209 in FIGS. 1 and 2, can use the stored file directory images 1102 and 1104 to implement the file synchronization techniques described herein. For example, appliance 105 with mounting system 406 and synchronization module 408, can store a file directory image 1102 representing file directory 118 of server 104 and file directory image 120 representing file directory 120 for server 106. Synchronization module 408 can compare the images 1102 and 1104 to determine if the servers have modified, added, or deleted a file. If any of the changes occur, synchronization module 408 performs operations to synchronize the file directories 118 and 120 for servers 104 and 106, respectively, as described below.

B. File Synchronization Techniques

The following methods of FIGS. 5-8 illustrate the file synchronization techniques for full asynchronous master-to-master file synchronization. The following methods can be implemented by a network appliance having a synchronization module or by a server with a synchronization module, as described herein. The synchronization module can keep track of all file changes to a file directory on one or more systems. For example, changes such as file modification, addition, or deletion can be tracked.

FIG. 5 illustrates a basic flow diagram of a method 500 for synchronizing file system directories on remote systems. Initially, a file system directory is scanned or mounted (step 502). For example, referring to FIG. 1, network appliance 105 can scan file directory 118 of server 104 to determine how file directory 118 is composed and/or if a change occurred in file directory 118. The file system directory can be scanned periodically, or by way of notice internally (e.g., by way of interrupts), a message from another system to initiate the file system directory scan, or manually. Network appliance 105 can then store information (e.g., an image) associated with the scanned file system directory locally in one or more memory devices (step 504). The stored information can include a record for each directory and file within the file system directory to provide a complete map of the file system directory. Such information or records can be used to compare with information or records of a previous scan of the file system directory.

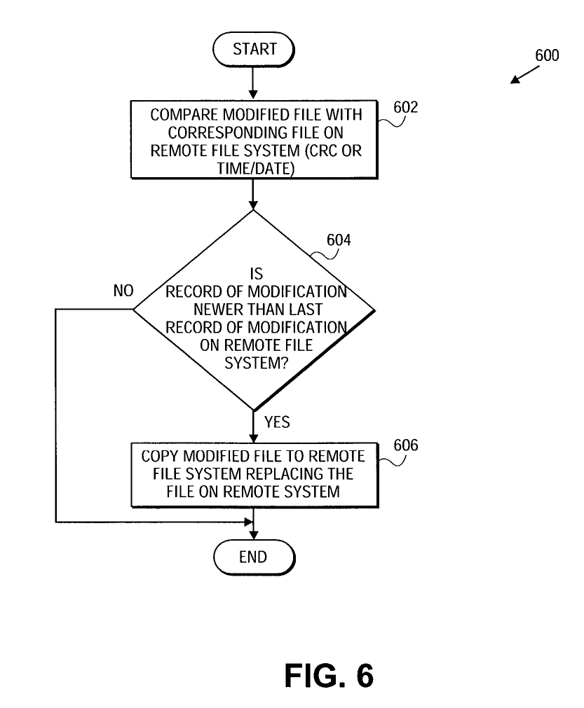

The results of the scanned file system directory are compared with the results of a prior scan of the file system directory (step 506). For example, referring to FIG. 11, file directory image 1 (1102) can represent a current scan of the file system directory and the file directory image 2 (1104) can represent a previous scan of the file system directory. The records or information related to the current image and the previous image are compared to determine if changes occurred to the file system directory (step 508). For example, by comparison of the records, changes such as file modification, file addition, and file deletion can easily be determined. Each change is synchronized with a remote file system directory (step 510). The changes can be handled on a file by file basis. The following methods described in FIGS. 6, 7, and 8 detail synchronization of file system directories for a file modification, file addition, and file deletion.

FIG. 6 illustrates a flow diagram of a method 600 for file synchronization on multiple systems based on a file modification. Initially, a comparison is made between a modified file with a corresponding file on a remote file system (step 602). For example, in one implementation, network appliance 105 can compare a record of a modified file from a current image of the file directory 118 with a corresponding record from a current image of the file directory 120. These images can be stored locally on the appliance 105, or, alternatively, the image for file directory 120 can be stored on network appliance 107. If stored on network appliance 107, network appliance 105 can send a message to network appliance 107 of the file modification

A check is made if the record of modification is newer than the last record of modification on remote system (step 604). For example, if both records for file directory 118 and 120 are stored locally on network appliance 105, network appliance 105 can compare a current image of file directory 118 with a current image of file directory 120 to determine which modification is newer and if the file modification is needed on file directory 120. The time/date record for the modified file can be compared for the same on file directory 120. If the modification is newer for file directory 118, the modified file is copied to the remote file system (e.g., file directory 120 on server 106). This action then replaces the file on the remote system (step 606). If the record is not newer, no action is taken because it is not the most recent modification. If the modification is newer on file directory 120, network appliance 107 using its synchronization mechanism will ensure that the modification is propagated to file directory 118 through network appliance 105. The above method can thus operate concurrently or at different instances at both a local computing device or system and a remote computing device or system.

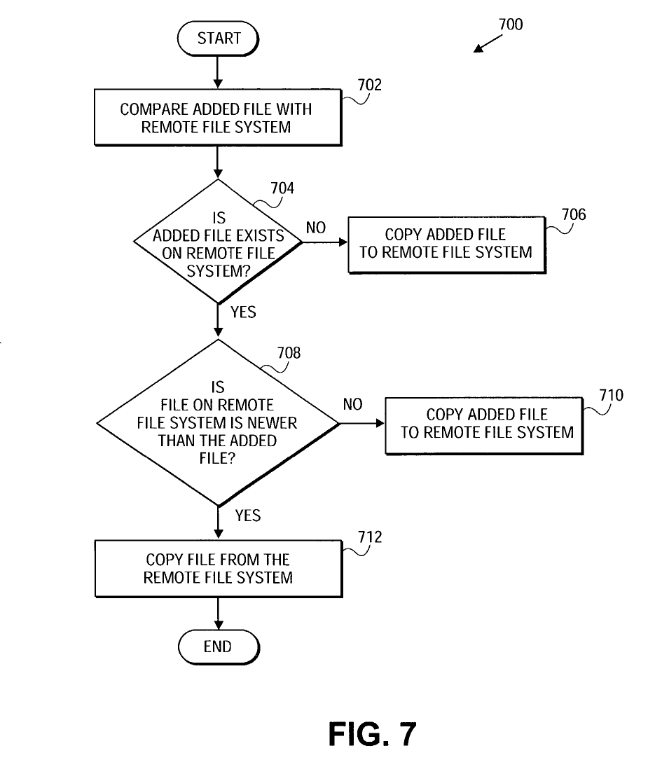

FIG. 7 illustrates a flow diagram of a method 700 for file synchronization on multiple systems based on a file addition. Initially, the added file is compared with the remote file system for a corresponding file (step 702). A check is made to determine if the added file exists on the remote file system (step 704). If it does not, the added file is copied to the remote file system (step 706). The copied file time/date stamp is updated to match the local copy of the added file. If the added file does exist on the remote file system, a check is made to determine if the file on the remote file system is newer than the added file (step 708). This can be determined by checking the file date created of the local copy with the remote file system copy. If it is not, the added file is copied to the remote file system (step 710). If it is, the file is copied from the remote file system (712). The above method can thus operate concurrently or at different instances at both a local computing device or system and a remote computing device or system.

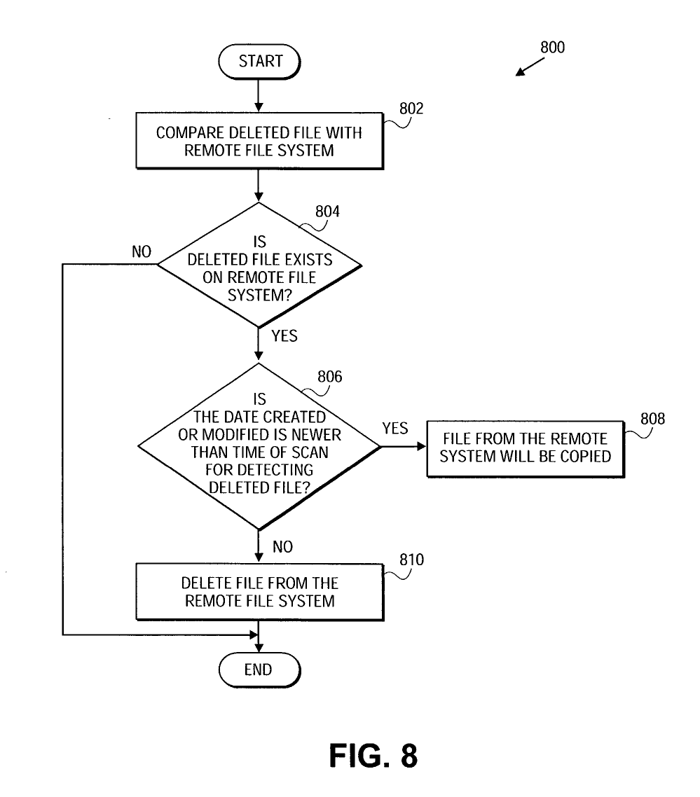

FIG. 8 illustrates a flow diagram of a method 800 for file synchronization on multiple systems based on a file deletion. Initially, the deleted file is compared with the remote file system for determining if it exists on a remote system (step 802). A check is made to determine if the deleted file exists on the remote file system (step 804). If it does not, no action is taken and the process ends. If it does, a check is made to determine if the date created or modified is newer than the time of the scan for detecting the deleted file (step 806). If it is newer, the file from the remote file system is copied to the local file system (step 808). If not, the file is deleted from the remote file system. The above method can thus operate concurrently or at different instances at both a local computing device or system and a remote computing device or system.

The above methods can be implemented on the remote system as well such that file synchronization occurs or is initiated from a remote system. In this manner, file synchronization can occur in multiple directions. Many variations to the above methods can be implemented. For example, any file that is modified or deleted can be saved or archived in a separate directory on an appliance or other computing system. The time/date of the saved or archived files can be recorded. Certain files, directories, or subdirectories can designated as not involved for file synchronization

Other variations are possible. For example, in a push/pull file synchronization environment, a file can be created on the remote file system between the time a directory scan is done and the file copy is created. This will have the effect of incorrectly deleting new files on the remote file system. To prevent this, the time/date is recorded at the time the local directory scan and database creation is started. This time/date stamp is used in calculations for file additions and deletions.

Since the time and date may not be exactly coordinated between remote nodes involved in the synchronization process, the local node date and time is recorded at the time the synchronization process is started. The synchronization protocol first retrieves the remote server node date and time and records this. This date stamp is used to calculate a time and date delta between the two nodes in the synchronization process. When comparing time and dates of files during the Add/Delete process, date comparison logic takes into account the date/time offset to synchronize the file addition and deletion events. Example: The remote file modified-date is Rmt-Date-Modified plus (Local-Date minus Remote-Date). This results in a local file date synchronized with a remote file date.

FIG. 12 illustrates an exemplary peer-to-peer server environment 1200 for secured file synchronization. The environment 1200 includes a synchronization server 1 (1202), a synchronization server 2 (1204), and a synchronization server 3 (1206). Servers 1, 2, and 3 can be configured with the mounting system or module and synchronization module described above to maintain file synchronization across servers 1, 2, and 3. In this example, servers 1, 2, and 3 can send secured data using, e.g., shared key transfer mechanisms. All traffic between the servers can be encrypted via virtual private network (VPN) techniques.

Referring to FIG. 12, server 1 has copied “HR data” and “Engineering Data” from server 2 and server 3. In this example, servers 2 and 3 cannot share data directly between themselves because there is no direct communication connection or channel. Server 2 and 3 must access the data via server 1. Server 1 may include a mounting system and a synchronization module to facilitate file synchronization for both servers 2 and 3 using a secured data channel. For example, “HR Data” can be new to server 2, which is propagated to server 3 via server 1 using the above techniques. Likewise, “Engineering Data” can be new to server 3, which is propagated to server 2 via 2 using the above techniques. Server 1 can thus perform secured file synchronization between multiple servers.

Thus, a method and system for full asynchronous master-to-master file synchronization have been described. The above implementations allow large file directories to be synchronized or mirrored on one or more remote computing devices. For instance, common-shared data file libraries can be synchronized across a WAN such as the Internet.

Furthermore, while there has been illustrated and described what are at present considered to be exemplary implementations and methods of the present invention, various changes and modifications can be made, and equivalents can be substituted for elements thereof, without departing from the true scope of the invention. In particular, modifications can be made to adapt a particular element, technique, or implementation to the teachings of the present invention without departing from the spirit of the invention.

In addition, the described implementations comprise computing systems, which can run software to implement the methods, steps, operations, or processes described herein. Other embodiments of the invention will be apparent from consideration of the specification and practice of the invention disclosed herein. Therefore, it is intended that the specification and examples be considered as exemplary only, with a true scope and spirit of the invention being indicated by the following claims.

What is claimed is:

1. A method for file synchronization between at least a first system and a second system coupled via a network, each system having a file directory with one or more files, the method comprising:
obtaining information associated with a first file directory of the first system and information associated with a second file directory of the second system, the obtained information determining a layout of the first file directory and second file directory;
storing the obtained information associated with the first and second file directories;
comparing the stored information associated with the first file directory with the information associated with the second file directory to determine if the first and second file directories match; and
modifying at least one of the first file directory and the second file directory if the file directories do not match to maintain synchronization of the file directories.

2. The method of claim 1, wherein obtaining the first and second file directory information includes:
scanning a first file directory on the first system and a second file directory on the second system to obtain an image of the first and second file directories.

3. The method of claim 2, wherein storing the obtain first and second file directory information includes storing the images of the first and second file directories.

4. The method of claim 1, wherein comparing the first and second file directories includes:
detecting at least one of a file modification, file addition, or file deletion change.

5. The method of claim 4, further comprising:
copying or deleting a file from at least one of the first and second file directories to maintain file directory synchronization between the first and second file directories.

6. A computing system comprising:
a mounting module to mount a first image of a file directory of a local system and a second image of the file directory of the local system; and
a synchronization module to compare the first image and the second image of the file directory of the local system in determining a change in the file directory of the local system and to synchronize the file directory of the local system with a file directory of a remote system if a change is determined.

7. The computing system of claim 6, wherein the computing system is a network appliance coupled to the local system and the remote system via a network.

8. The computing system of claim 6, wherein the network appliance is configured within the local system.

9. The computing system of claim 6, wherein the mounting module scans the file directory of the local system to obtain the first and second images of the file directory.

10. The computing system of claim 6, wherein the synchronization module detects a file modification change, a file addition change, or a file deletion change on the local system.

11. The computing system of claim 6, wherein the synchronization module initiates copying or deleting of a file from at least one of the file directories on the local system and remote system to maintain synchronization of the file directories on the local system and remote system.

12. A computer-readable medium containing instructions, which if executed by a computing system, cause the computing system to perform a method for file synchronization between at least a first system and a second system coupled via a network, each system having a file directory with one or more files, the method comprising:
obtaining information associated with a first file directory of the first system and information associated with a second file directory of the second system, the obtained information determining a layout of the first file directory and second file directory;
storing the obtained information associated with the first and second file directories;
comparing the stored information associated with the first file directory with the information associated with the second file directory to determine if the first and second file directories match; and
modifying at least one of the first file directory and the second file directory if the file directories do not match to maintain synchronization of the file directories.
